(19) United States
(12) Patent Application Publication
(10) Pub. No.: US 2011/0234619 A1
(43) Pub. Date: Sep. 29, 2011

(54) HEAD-MOUNTED DISPLAY

(75) Inventor: Atsushi TOKUNAGA, Ama-shi (JP)

(73) Assignee: BROTHER KOGYO KABUSHIKI KAISHA, Nagoya-shi (JP)

(21) Appl. No.: 13/153,019

(22) Filed: Jun. 3, 2011

Related U.S. Application Data
(63) Continuation-in-part of application No. PCT/JP2009/070836, filed on Dec. 14, 2009.

(30) Foreign Application Priority Data
Dec. 16, 2008 (JP) 2008-319144

(51) Int. Cl. G09G 5/02; G09G 5/00

(52) U.S. Cl. 345/589; 345/8; 345/619

(57) ABSTRACT

A head-mounted display includes an image display portion configured to optically emit image light to the eyes of a user, an approaching object detection portion configured to detect an object approaching the user, a direction detection portion that detects an approaching direction from which the object detected by the approaching object detection portion approaches based on a detection result by the approaching object detection portion, and a display control portion configured to guide a line of sight of the user in the approaching direction in a display region in which a display image is displayed which is visually recognized by the user based on the image light emitted by the image display portion.

### CROSS-REFERENCE TO RELATED APPLICATION

This application is a continuation-in-part of International Application No. PCT/JP2009/070836, filed Dec. 14, 2009, which claims priority from Japanese Patent Application No. 2008-319144, filed on Dec. 16, 2008. This disclosure of the foregoing application is hereby incorporated by reference in its entirety.

### BACKGROUND

The present disclosure relates to a head-mounted display.

Conventionally, a head-mounted display (hereinafter abbreviated as an HMD) has been known which detects an obstacle moving close to an image output unit so as to avoid it from coming in contact with the obstacle. If a distance sensor in the HMD detects the approaching obstacle, the image output unit is moved automatically so that it can be avoided from coming in contact with the obstacle.

### SUMMARY

However, this type of HMD would have a problem in that although its user can know an obstacle is approaching the user, the user cannot know a direction from which it is approaching. The user of the HMD is liable to be careless about the outside world because the user watches a displayed image while the user is working or moving. Therefore, when the displayed image only gets out of his sight because the approaching obstacle is detected and so the image output unit is automatically moved off from the user's eyesight, a bit of time is needed for the user to recognize the approaching obstacle. If the user may be caused to pay attention in the approaching direction of the obstacle, the time necessary for the user to recognize the approaching obstacle can be shortened remarkably, thereby significantly having an effect in avoiding the approaching obstacle easily.

It is one object of the present disclosure is to provide a HMD that can notify the user of a direction from which an obstacle is approaching.

According to a first aspect of the present disclosure, there is provided a head-mounted display includes an image display portion configured to optically emit image light to the eyes of a user, an approaching object detection portion configured to detect an object approaching the user, a direction detection portion configured to detect an approaching direction from which the object detected by the approaching object detection portion approaches based on a detection result by the approaching object detection portion, and a display control portion configured to guide a line of sight of the user in the approaching direction in a display region in which a display image is displayed which is visually recognized by the user based on the image light emitted from the image display portion.

According to a second aspect of the present disclosure, there is provided a head-mounted display includes an image display configured to be mounted on the head of a user, an approaching object detector configured to detect an object approaching the user, and a processor that is configured to execute instructions that detect an approaching direction from which the object detected by the approaching object detector approaches based on a detection result by the approaching object detector, and cause the image display to display a display image corresponding to the approaching direction in a display region in which the display images visually recognized by the user are displayed by the image display.

### BRIEF DESCRIPTION OF THE DRAWINGS

Embodiments of the disclosure will be described below in detail with reference to the accompanying drawings in which:

FIG. 1 is a diagram showing an external configuration of an HMD.

FIG. 2 is a schematic diagram of an electric configuration of the HMD.

FIG. 3 is a schematic diagram of a process in which image light is formed at a display section.

FIG. 4 is a schematic diagram showing a camera shootable region, an eyesight region, an image displayable region, and an image display region.

FIG. 5 is a flowchart of main processing to detect an object approaching the HMD.

FIG. 6 is a flowchart of a subroutine for approaching object detection processing.

FIG. 7 is a flowchart of a subroutine for alarm display processing.

FIG. 8 is a schematic diagram showing the camera shootable region, the eyesight region, the image displayable region, and the image display region in a case where alarm display is provided.

FIG. 9 is a schematic diagram showing the camera shootable region, the eyesight region, the image displayable region, and the image display region in a ease where the image display region is moved.

FIG. 10 is a schematic diagram showing the camera shootable region, the eyesight region, the image displayable region, and the image display region in a case where one portion of the image display region is erased.

### DETAILED DESCRIPTION OF EMBODIMENTS

The following will describe one embodiment of an HMD with reference to the drawings. It is to be noted that the drawings will be used only to explain technological features that the present disclosure can employ. The described configuration of a device and flowcharts of various types of processing are given just for ease of explanation, but without any intended limitation.

In description of the HMD of the present disclosure, a retinal scanning type display will be used as an example. The retinal scanning type display scans light flux that complies with an image signal in a two-dimensional direction and emits the scanned light to the eyes, thereby forming an image displayed on the retina. However, the HMD is not limited to the retinal scanning type. The HMD may be equipped with any other image display device such as a liquid crystal display (LCD) or an organic electro-luminescence (EL) display, for example.

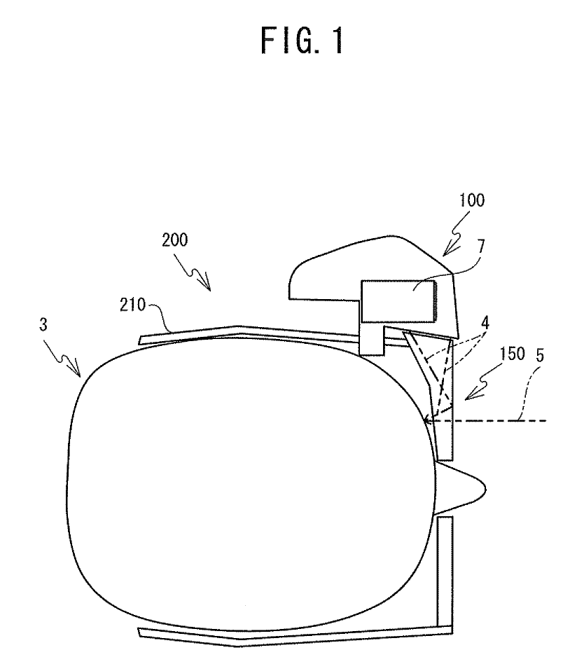

As shown in FIG. 1, an HMD 200 scans laser light (hereinafter referred to as “image light 4”) modulated in accordance with an image signal and emits it to the retina of at least one of the eyes of a user 3. Accordingly, an image is directly projected onto the retina of the user 3, and the user 3 can recognize the image visually.

The HMD 200 includes an emitting device 100, a prism 150, a head-worn section 210, and a camera 7. The emitting device 100 emits the image light 4 in accordance with an image signal toward the prism 150 from a side of the user 3. The prism 150 is located to a fixed position with respect to the emitting device 100 and equipped with a beam splitter section (not shown). The head-worn section 210 supports the emitting device 100 and the prism 150 onto the head of the user 3. The camera 7 picks up an image of the outside world. In this configuration, the prism 150 reflects the image light 4 incoming from the emitting device 100 so that it may enter the eyes of the user 3 and, simultaneously, transmits outside light from the outside world through itself so that it may enter the eyes of the user 3. Accordingly, the user 3 can visually recognize actual eyesight and an image based on the image light 4 emitted from the emitting device 100.

In the present embodiment, the HMD 200 is configured so that the prism 150 may enable the user to visually recognize the outside light 5 and the image light 4 simultaneously. However, the present disclosure is not limited to this configuration. For example, the HMD 200 may be equipped with a half mirror in place of the prism 150. In this case, the image light 4 from the emitting device 100 is reflected by the half mirror to enter the eyes of the user 3, while simultaneously the outside light 5 passes through the half mirror to enter the eyes of the user 3.

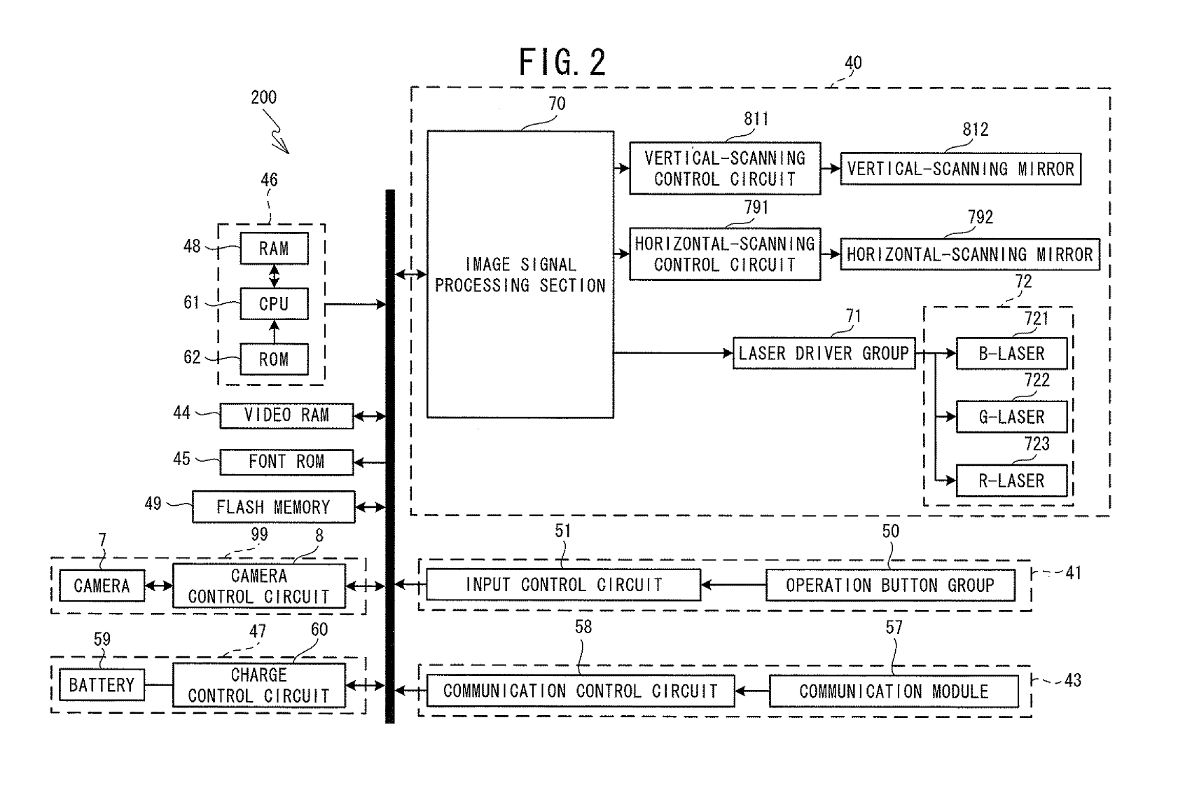

As shown in FIG. 2, the HMD 200 is equipped with a display section 40, an input section 41, a communication section 43, a flash memory 49, a video RAM 44, a font ROM 45, a control section 46, a camera control section 99, and a power supply section 47.

The display section 40 projects an image onto the retina of the user 3. The display section 40 is equipped with an image signal processing section 70, a laser group 72, and a laser driver group 71. The image signal processing section 70 is electrically connected to the control section 46 via a bus. The image signal processing section 70 receives information of an image (hereinafter referred to as “image information”) to be shown to the user 3 from the control section 46 and converts this image information into various signals necessary to directly project the image onto the retina of the user 3. The laser group 72 includes a blue output laser (B-laser) 721, a green output laser (G-laser) 722, and a red output laser (R-laser) 723 so that blue laser light, green laser light, and red laser light may be emitted respectively. The laser driver group 71 is electrically connected to each of the B-laser 721, the G-laser 722, and the R-laser 723, to control so that the laser light may be emitted from the laser group 72. The image signal processing section 70 is electrically connected to the laser driver group 71 so that the desired laser light can be emitted at desired timing.

Further, the display section 40 is equipped with a vertical-scanning mirror 812, a vertical-scanning control circuit 811, a horizontal-scanning mirror 792, and a horizontal-scanning control circuit 791. The vertical-scanning mirror 812 reflects the laser light emitted from the laser group 72 in a vertical direction and scans it. The vertical-scanning control circuit 811 controls driving of the vertical-scanning mirror 812. The horizontal-scanning mirror 792 reflects the laser light emitted from the laser group 72 in a horizontal direction and scans it. The horizontal-scanning control circuit 791 controls driving of the horizontal mirror 792. The vertical-scanning control circuit 811 is electrically connected to the vertical-scanning mirror 812. The horizontal-scanning control circuit 791 is electrically connected to the horizontal-scanning mirror 792. The image signal processing section 70 is electrically connected to each of the vertical-scanning control circuit 811 and the horizontal-scanning control circuit 791 and so can control so that the laser light may be reflected in a desired direction.

The input section 41 is equipped with an operation button group 50 and an input control circuit 51, to perform various operations including data input. The operation button group 50 is equipped with various function keys and electrically connected to the input control circuit 51. The input control circuit 51 is electrically connected to the control section 46 and so notifies the control section 46 of an operation, if it detects, of any one of the keys in the operation button group 50. The control section 46 recognizes information input by the key in the operation button group 50.

The communication section 43 is equipped with a communication module 57 and a communication control circuit 58, to transmit and receive image information etc. The communication module 57 is electrically connected to the communication control circuit 58, to receive the image signal etc. by using a wireless radio wave. The communication control circuit 58 controls the communication module 57. The control section 46 is electrically connected to the communication control circuit 58 via a bus, to acquire the image signal from the communication control circuit 58. It is to be noted that the communication method for the communication module 57 is not limited in particular but the conventionally known wireless communication method can be used. For example, a wireless communication method can be used which conforms to the Bluetooth (registered trade mark) standard, the Ultra Wide Band (UWB) standard, the wireless LAN (IEEE802. 11b, 11g, 11n, etc.) standard, or the Wireless USB standard. Further, a wireless communication method that conforms to the Infrared Data Association (IrDa) standard by use of infrared can be used.

The camera control section 99 is equipped with the camera 7 and a camera control circuit 8. The camera 7 picks up an image of the outside world. The control circuit 8 controls the camera 7. The camera 7 is used to pick up the image of the outside world. The camera control circuit 8 is electrically connected to the control section 46 and the flash memory 49 via a bus. The camera control circuit 8 acquires the images of the outside world picked up with the camera 7.

The power supply section 47 is equipped with a battery 59 and a charge control circuit 60. The battery 59 is rechargeable and serves as a power supply to drive the HMD 200. The charge control circuit 60 charges the battery 59 by supplying it with power fed from a charging adapter (not shown) and also supplies power of the battery 59 to the HMD 200.

The flash memory 49 stores various set values etc. of functions which are used in the HMD 200. The video RAM 44 stores image data of images (graphics) and texts which are displayed on the display section 40. The font ROM 45 stores font data of the texts which are displayed on the display section 40. The flash memory 49, the video RAM 44, and the font ROM 45 are each electrically connected to the control section 46 via a bus so that the control section 46 can refer information stored in each of those storage devices.

The control section 46 is equipped with at least a CPU 61, an ROM 62, and an RAM 48, to control an entirety of the HMD 200. The control section 46 performs predetermined operations in response to the user 3's manipulations on the input section 41, for example, displays desired information on the display section 40. The ROM 62 stores a variety of programs. The RAM 48 temporarily stores various types of data. Further, the control section 46 performs various types of processing when the CPU 61 reads the various programs stored in the ROM 62. The RAM 48 provides a storage region to store a variety of flags and data necessary when the CPU 61 performs processing.

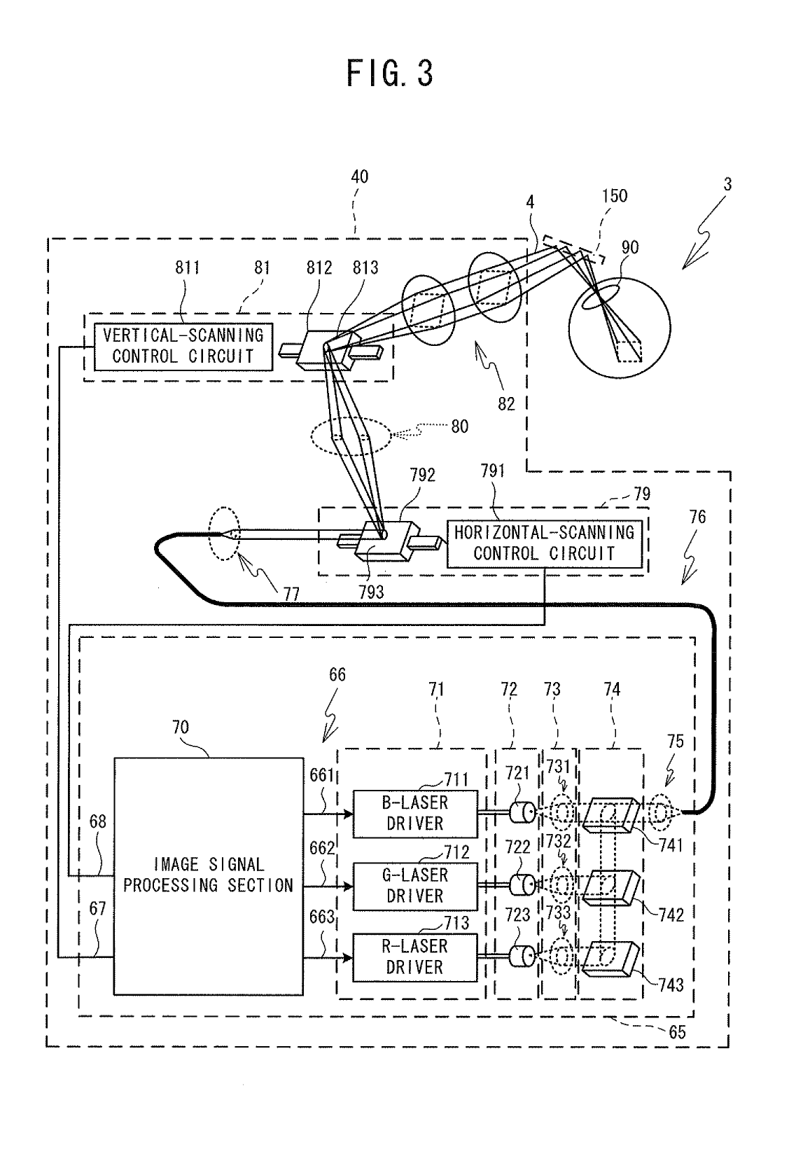

A description will be given of a detailed configuration of the display section 40 as well as a process of forming the image light 4 with reference to FIG. 3. The display section 40 is equipped with a light source unit section 65, a collimation optical system 77, a horizontal-scanning system 79, a first relay optical system 80, a vertical-scanning system 81, and a second relay optical system 82. The light source unit section 65 is equipped with the image signal processing section 70, the laser driver group 71, the laser group 72, a collimation optical system 73, a dichroic mirror group 74, and a coupling optical system 75. The horizontal-scanning system 79 is equipped with a horizontal-scanning control circuit 791 and a horizontal-scanning mirror 792. The vertical-scanning system 81 is equipped with a vertical-scanning control circuit 811 and a vertical-scanning mirror 812.

A description will be given in detail of a configuration of the light source unit section 65 with reference to FIGS. 2 and 3. The image signal processing section 70 is electrically connected to the control section 46. To project desired information onto the retina, the control section 46 inputs the image signal of image information deployed in the video RAM 44 into the image signal processing section 70. The image signal processing section 70 generates luminance signals (B-luminance signal, G-luminance signal, and R-luminance signal), a vertical-synchronization signal, and a horizontal-synchronization signal which are necessary to project the image information onto the retina. The luminance signals are transmitted via luminance signal lines 66 (B-luminance signal line 661, G-luminance signal line 662, and R-luminance signal line 663) to the laser driver group 71 (B-laser driver 711, G-laser driver 712, and R-laser driver 713). Specifically, the B-luminance signal is transmitted via the B-luminance signal line 661 to the B-laser driver 711, the G-luminance signal is transmitted via the G-luminance signal line 662 to the G-laser driver 712, and the R-luminance signal is transmitted via the R-luminance signal line 663 to the R-laser driver 713. Further, the vertical-synchronization signal is transmitted via a vertical-synchronization signal line 67 to a vertical-scanning control circuit 811 in the vertical-scanning system 81. Further, the horizontal-synchronization signal is transmitted via a horizontal-synchronization signal line 68 to a horizontal-scanning control circuit 791 in the horizontal-scanning system 79.

The laser driver group 71 is electrically connected to the laser group 72 (each of B-laser 721, G-laser 722, and R-laser 723). The laser driver group 71 drives the laser group 72 so that it may emit laser light whose intensity is modulated, on the basis of the respective luminance signals received via the luminance signal line 66 (the B-luminance signal line 661, the G-luminance signal line 662, and the R-luminance signal line 663).

The light source unit section 65 is equipped with a collimation optical system 73 (731-733), a dichroic mirror group 74 (741-743), and the coupling optical system 75. The collimation optical system 73 (731-733) can collimate three colors (blue, green, and red) of laser light emitted from the laser group 72 to parallel light respectively. The dichroic mirror group 74 (741-743) can couple the laser light collimated in the collimation optical system 73. The coupling optical system 75 guides the coupled laser light to an optical fiber 76. It is to be noted that as the laser group 72 (the B-laser 721, the G-laser 722, and the R-laser 723), a solid laser or a semiconductor laser such as a laser diode may be utilized.

The horizontal-scanning system 79 is equipped with a horizontal-scanning mirror 792 controlled by the horizontal-scanning control circuit 791. Laser light made incident upon a deflected surface 793 of the horizontal-scanning mirror 792 is scanned horizontally in synchronization with the horizontal-synchronization signal received via the horizontal-synchronization signal line 68. The horizontal-scanning system 79 in the present embodiment horizontally scans the laser light for each scanning line for a displayed image (one example of primary scanning).

The first relay optical system 80 is provided in the display section 40. The first relay optical system 80 guides the horizontally scanned laser light to the vertical-scanning system 81. The vertical-scanning mirror 812 controlled by the vertical-scanning control circuit 811 is provided in the vertical-scanning system 81. Laser light made incident upon a deflected surface 813 of the vertical-scanning mirror 812 is scanned vertically in synchronization with the vertical-synchronization signal received via the vertical-synchronization signal line 67. The vertical-scanning system 81 in the present embodiment vertically scans the laser light from the first scanning line toward the last scanning line each frame of a displayed image (one example of secondary scanning).

The second relay optical system 82 that guides the vertically scanned laser light (image light 4) to the prism 150 is provided in the display section 40. The image light 4 guided by the second relay optical system 82 is made incident upon the prism 150. The prism 150 is disposed between the second relay optical system 82 and a pupil 90 of the user 3. The prism 150 totally reflects the image light 4 and guides it to the pupil 90 of the user 3.

The horizontal-scanning system 79 is configured to scan laser light faster (i.e., at a higher frequency) than the vertical-scanning system 81. The first relay optical system 80 is configured so that the horizontal-scanning mirror 792 and the vertical-scanning mirror 812 may be conjugated with each other. The second relay optical system 82 is configured so that the vertical-scanning mirror 812 and the pupil 90 of the user 3 may be conjugated with each other.

A description will be given of a process up to projecting an image onto the retina of the user 3 by the image signal with reference to FIG. 3.

When the image signal processing section 70 provided in the light source unit section 65 receives the image signal, the image signal processing section 70 generates the luminance signals for emitting the respective blue, green, and red laser lights and outputs them to the luminance signal lines 66 (B-luminance signal line 661, G-luminance signal line 662, and R-luminance signal line 663). Further, the image signal processing section 70 generates the horizontal-synchronization signal and the vertical-synchronization signal and outputs them to the horizontal-synchronization signal line 68 and the vertical-scanning signal line 67, respectively.

The laser driver group 71 outputs a drive signal to the laser group 72 based on the luminance signals received via the luminance signal lines 66.

Based on this drive signal, the laser group 72 generates laser light having a modulated intensity. The generated laser lights are provided to the collimation optical system 73. Each laser light is collimated in the collimation optical system 73 into parallel lights. Then, the laser lights collimated to the parallel lights are made incident upon the dichroic mirror group 74. The dichroic mirror 74 combines the laser lights collimated to the parallel ones into one laser light. The combined laser light is made incident upon the optical fiber 76 by the coupling optical system 75.

The laser light incident upon the optical fiber 76 is guided to the collimation optical system 77, to be made incident upon the horizontal-scanning system 79.

The horizontal-scanning mirror 792 oscillates so that its deflected surface 793 may reflect the incident light horizontally, in synchronization with the horizontal-synchronization signal received via the horizontal-synchronization signal line 68. The laser light made incident upon the deflected surface 793 is scanned horizontally in synchronization with the horizontal-synchronization signal received via the horizontal-synchronization signal line 68. The horizontally scanned laser light is emitted to the vertical-scanning system 81 via the first relay optical system 80.

The first relay optical system 80 is adjusted so that the deflected surface 793 of the horizontal-scanning mirror 792 may be conjugated with the deflected surface 813 of the vertical-scanning mirror 812. An optical face tangle error of the horizontal-scanning mirror 792 is corrected.

The vertical-scanning mirror 812 oscillates so that its deflected surface 813 may reflect the incident light vertically, in synchronization with the vertical-synchronization signal received via the vertical-synchronization signal line 67. The laser light made incident upon the deflected surface 813 of the vertical-scanning mirror 812 is scanned vertically in synchronization with the vertical-synchronization signal received via the vertical-synchronization signal line 67.

The laser light is scanned two-dimensionally in the vertical direction and the horizontal direction respectively by the horizontal-scanning system 79 and the vertical-scanning system 81. The second relay optical system 82 is arranged so that the deflected surface 813 and the user's pupil 90 may be conjugated with each other. The laser light is made incident upon the user 3's pupil 90 via the second relay optical system 82 and the prism 150, to be projected onto the user 3's retina.

Through the described process, the laser light is scanned two-dimensionally to be projected onto the user 3's retina, so that the user 3 can recognize an image based on the laser light, that is, the image light 4.

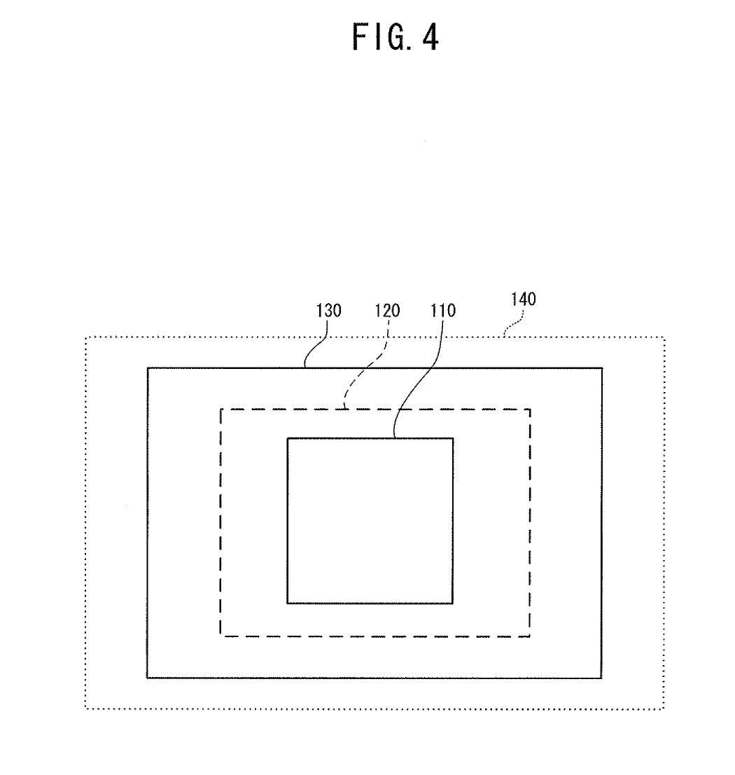

A description will be given of various display regions projected onto the retina of the user 3 of the HMD 200, a region that can be recognized by the user 3, and a region that can be shot by the camera 7 with reference to FIG. 4. The user 3 can see an image in an eyesight region 130 in a state where the user wears the HMD 200. Inside the eyesight region 130, there is an image displayable region 120. At the midsection of a further inside of the image displayable region 120, there is an image display region 110. Outside the eyesight region 130, there is a camera shootable region 140. The user 3 can recognize the eyesight region 130. In the image displayable region 120, the user 3 can recognize image information based on the image light 4 projected from the HMD 200 onto the retina. In the image display region 110, an image is displayed. In the camera shootable region 140, things can be shot with the camera 7 mounted on the HMD 200. The camera shootable region 140 is larger than the eyesight region 130 that can be recognized by the user 3. The HMD 200 usually displays the image on the image display region 110.

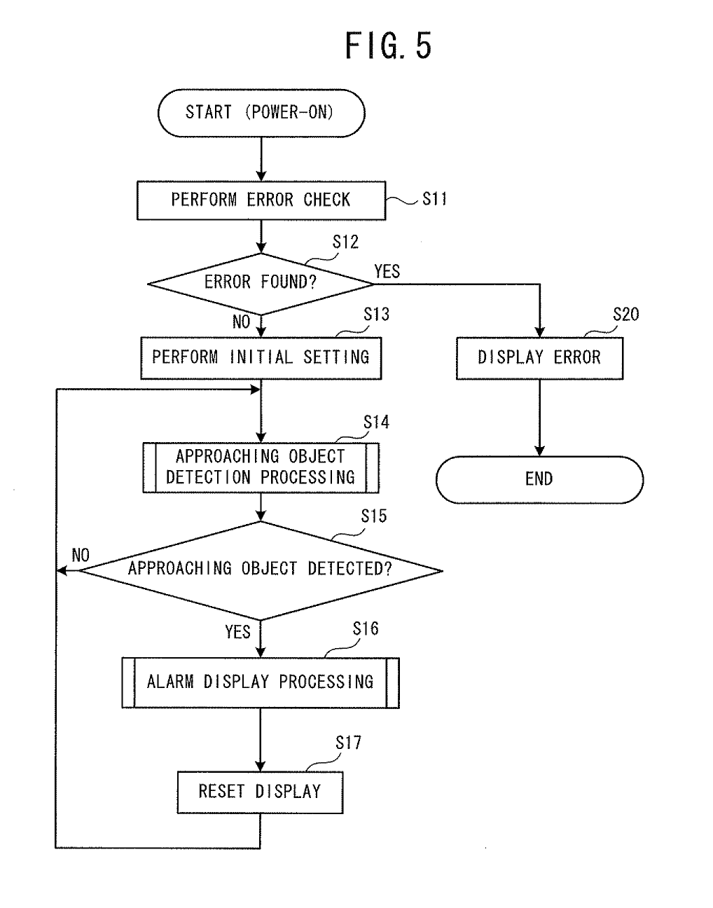

A description will be given of main processing configured to detect an object (hereinafter referred to as “approaching object”) approaching the HMD 200 with reference to FIG. 5. The following main processing will be performed by the CPU 61 based on a predetermined program stored in the ROM 62. The main processing starts when the power supply for the HMD 200 is actuated and ends when it is turned off. The other processing is performed by the HMD 200 in other tasks. Description of the other processing will be omitted.

When the main processing starts, error check is performed (S11). In the error check, it is decided whether there is any failure in the camera 7 configured to detect an approaching object, the camera control circuit 8, etc. If it is decided in the error check that there is a failure in the camera 7, the camera control circuit 8, etc. (YES in S12), error display is indicated in the image displayable region 120 (S20), to end the main processing. The error display involves indication of a message, for example, “A camera failure is detected”.

If it is decided in the error check that there is no failure in the camera 7, the camera control circuit 8, etc. (NO in S12), initial setting is performed (S13). The initial setting may include calibration etc. to adjust lenses etc. of the camera 7, for example. Further, it may involve acquisition of information preset by the user 3 about whether the user needs to be warned of the approaching object, how to warn the user of it, for example.

Approaching object detection processing configured to detect an approaching object is performed (S14). The approaching object detection processing will be described in detail later. It is decided whether any approaching object is detected (S15). Whether the approaching object is detected is decided based on a result of the approaching object detection processing (S14). If the approaching object is detected (YES in S15), alarm display processing is performed (S16). The alarm display processing involves displaying information (hereinafter referred to as “guide information”) configured to guide the user 3's line of sight in a direction from which the object is approaching. The alarm display processing will be described in detail later. Subsequently, display reset processing is performed (S17). In the display reset processing, the guide information displayed in the alarm display processing (S16) is erased from the image displayable region 120 in a predetermined lapse of time. The predetermined lapse of time only needs to be long enough for the user 3 to recognize the guide information, for example, about two seconds. Subsequently, the processing goes to S14, where the approaching object detection processing (S14) is performed again.

If no approaching object is detected (NO in S15), the approaching object detection processing (S14) is performed again.

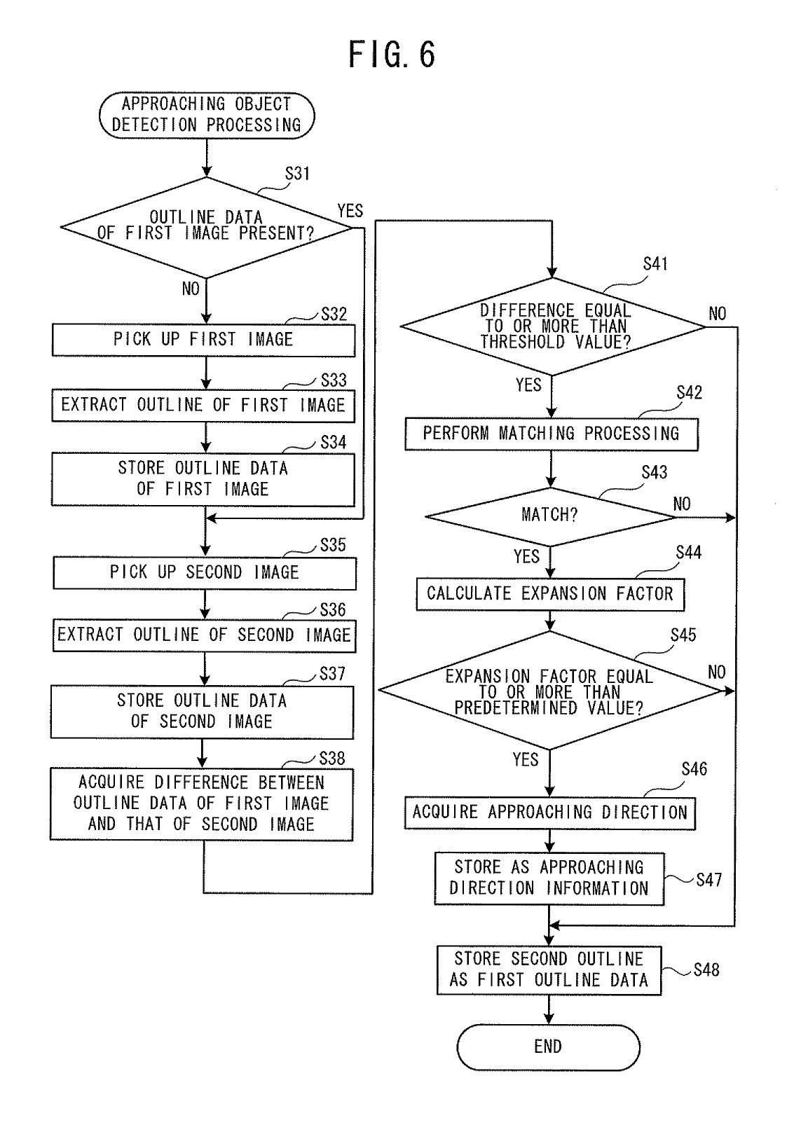

A description will be given of the approaching object detection processing with reference to FIG. 6. When the approaching object detection processing is performed, it is decided whether there is outline data of a first image (hereinafter referred to as “first outline data”) in a first outline data storage region (not shown) in the RAM 48 (S31). The first image is picked up with the camera 7 in processing in S32 to be described later. The first outline data is extracted in processing in S33 to be described later. When the first outline data is extracted, the first outline data is stored in the first outline data storage region in the RAM 48 (S34 to be described later).

If it is decided that the first outline data is not stored in the first outline data storage region (NO in S31), an image in the camera shootable region 140 (see FIG. 4) is picked up as the first image by using the camera 7 (S32). Pixels of the first image are transformed into the gray scale, thereby extracting the outline data of an object contained in the first image as the first outline data (S33).

To extract the outline data from an image, a known primary differentiation method is used. To extract an outline by using the primary differentiation method, a gradient of a density at each of pixels is obtained. With this, the intensity and the direction of the outline are calculated. A portion where a value of the density changes rapidly is extracted as the outline data. An x-directional differential gx and a y-directional differential gy are obtained as gx=p(x+1, y)−p(x, y) and gy=p(x, y+1)−p(x, y) respectively. Since data of a digital image is discrete, a differential is approximated by obtaining a difference between the adjacent pixels. p(x, y) gives a pixel value at a pixel (x, y). A intensity of the outline is calculated as E(x, y)=|gx|+|gy| from gx and gy. The direction of a vector (gx, gy) denotes the direction of the outline.

The first outline data acquired in S33 is stored in the first outline data storage region (not shown) in the RAM 48 (S34). Then, in a predetermined lapse of time, a second image is picked up (S35). The predetermined lapse of time only needs to be long enough to detect a disparity between the first image and the second image, for example, 1/30 seconds.

If it is decided that the first outline data is stored in the first outline data storage region (YES in S31), S32 to S34 are not performed, so that the processing goes from S31 to S35.

Outline data of an object contained in the second image acquired in S35 is extracted (S36). The outline data is extracted by using the same method as that used in S33. The outline data of the second image (hereinafter referred to as “second outline data”) is stored in a second outline data storage region (not shown) in the RAM 48 (S37).

A difference is obtained between the first outline data stored in the first outline data storage region and the second outline data stored in the second outline data storage region in the RAM 48 (S38). The difference refers to a difference between the first outline data and the second outline data at each of the pixels. In an image region containing a stationary object, the difference value is “0” because there is no difference in the image density value. In an image region containing a moving object, the difference value is larger than “0” because there is a change in the image density value.

It is decided whether there is a region (hereinafter referred to as “target region”) containing a pixel where the difference value acquired in S38 is equal to or more than a threshold value (S41). The threshold value is given to remove noise. If the threshold value is less than the threshold value, it is decided that the difference value is noise. If there is no target region (NO in S41), the second outline data is stored as the first outline data in the first outline data storage region in the RAM 48 (S48). The second outline data stored in the second outline data storage region in the RAM 48 is deleted.

If there is a target region (YES in S41), matching processing is performed between the first outline data target region and the second outline data target region (S42). The matching processing is performed in known template matching processing. The template matching processing uses a normalized correlation value NRML.

A pixel in the target region is denoted by K*L. A pixel value of the first outline data target region is denoted by T(x, y) and a pixel value of the second outline data target region is denoted by I(x, y). The normalized correlation value NRML(x, y) is given by the following equation:

$$NRML ( x , y ) = \frac{{\sum }_{P = 0}^{K} {\sum }_{q = 0}^{L} ( I ( x + p , y + q ) - \overline{I} ) ( T ( p , q ) - \overline{T} )}{( \begin{matrix}\sqrt{{\sum }_{P = 0}^{K} {\sum }_{q = 0}^{L} {( \overline{I} ( x + p , y + q ) - \overline{I} )}^{2}} \\ \sqrt{{\sum }_{P = 0}^{K} {\sum }_{q = 0}^{L} {( T ( p , q ) - \overline{T} )}^{2}}\end{matrix} )} \qquad [ Equation 1 ]$$

where T̅ is an average of pixel values in the target region (K*L pixels) in the first outline data; and
Ī is an average of pixel values in the target region (K*L pixels) in the second outline data.

As the image correlation is higher, the value of the normalized correlation value (x, y) approaches “1, 0” more and as the image correlation is lower, it approaches “0, 0” more. If there is no correlation, the normalized correlation value NRML (x, y) takes on a value of “0, 0”. If the first outline data target region and the second outline data target region match ideally, the normalized correlation value NRML (x, y) takes on a value of “1, 0”.

It is decided in the matching processing whether the first outline data target region and the second outline data target region match each other (S43). In the matching processing, it is decided whether the normalized correlation value NRML (x, y) is in excess of a predetermined value. If the normalized correlation value NRML (x, y) is in excess of the predetermined value, it is decided that the target regions match each other. If it is not decided that the target regions match each other (NO in S43), the processing goes to S48. The second outline data is stored as the first outline data in the first outline data storage region in the RAM 48 (S48). The second outline data stored in the second outline data storage region in the RAM 48 is deleted. The first outline data stored in the first outline data storage region provides the most recent outline data.

If it is decided that the target regions match each other (YES in S43), an enlargement factor is calculated (S44). The enlargement factor refers to a proportion of an area inside the second outline data target region with respect to that inside the first outline data target region. The enlargement factor is calculated by obtaining the square root of a ratio between the area inside the first outline data target region and that inside the second outline data target region.

It is decided whether the enlargement factor calculated in S44 is equal to or more than a predetermined value (S45). If an object approaches within a predetermined distance from the user 3 of the HMD 200, the enlargement factor increases. If it is decided that the enlargement factor is less than the predetermined value (NO in S45), the processing goes to S48. The second outline data is stored as the first outline data in the first outline data storage region in the RAM 48 (S48). The second outline data stored in the second outline data storage region in the RAM 48 is deleted.

If it is decided that the enlargement factor acquired in S44 is equal to or more than the predetermined value (YES in S45), a direction from which the object approaches (hereinafter referred to as “approaching direction information”) is acquired (S46). The approaching direction information refers to a direction corresponding to any one region in which the approaching object is detected among a total of nine regions (“right”, “left”, “upper”, “lower”, “front”, “upper right”, “lower right”, “upper left”, and “lower left”) obtained by dividing the camera shootable region 140 into three vertically and horizontally respectively. For example, if the approaching object is detected in the “right” region, the approaching direction information is “right”. The approaching direction information is stored in an approaching object direction storage area (not shown) in the RAM 48 (S47) and the processing goes to S48. The second outline data is stored as the first outline data in the first outline data storage region in the RAM 48 (S48). The second outline data stored in the second outline data storage region in the RAM 48 is deleted.

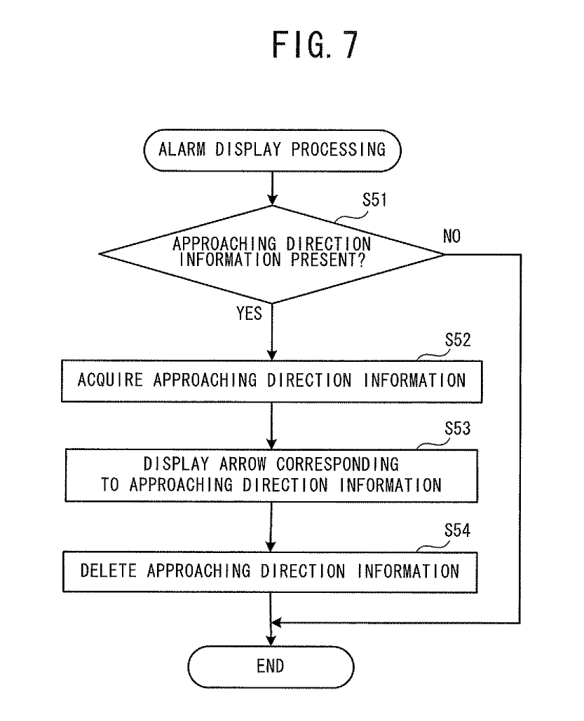

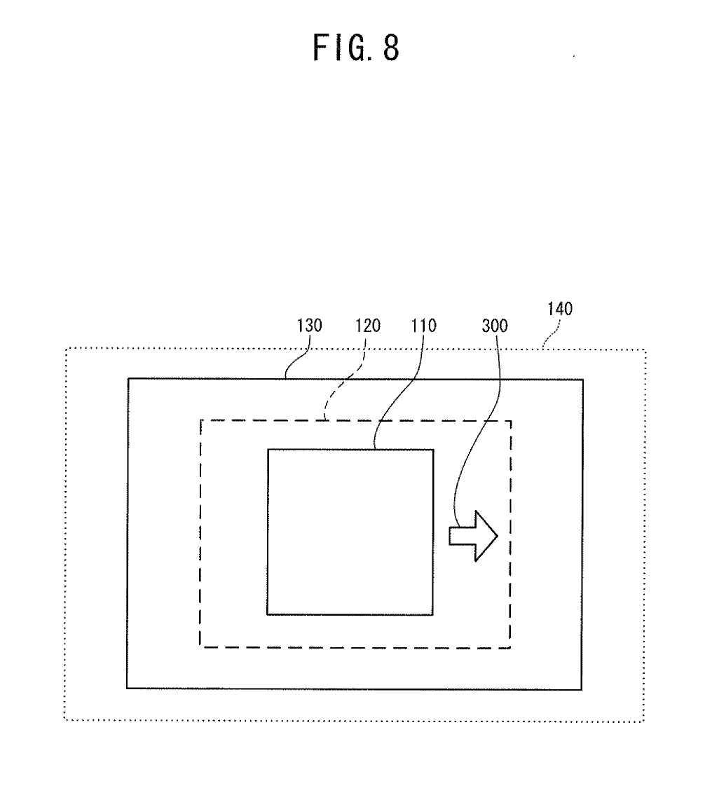

A description will be given of the alarm display processing with reference to FIGS. 7 and 8. When the alarm display processing starts, it is decided whether the approaching direction information is present (S51). The approaching direction information refers to information stored in the approaching object direction storage area in the RAM 48. If there is no approaching direction information in the approaching object direction storage area (NO in S51), the alarm display processing ends.

If it is decided that there is any approaching direction information in the approaching object direction storage area in the RAM 48 (YES in S51), the approaching direction information is acquired from the approaching object direction storage area in the RAM 48 (S52). An arrow denoting a direction that corresponds to the acquired approaching direction information is displayed in the image displayable region 120 (S53). For example, if the direction denoted by the approaching direction information is “right”, an arrow 300 is displayed in the “right” display region in the image displayable region 120 as shown in FIG. 8. The “right” display region is positioned to the center of the right side in each of a total of nine regions (“right”, “left”, “upper”, “lower”, “front”, “upper right”, “lower right”, “upper left”, and “lower left”) obtained by dividing the image displayable region 120 into three vertically and horizontally respectively. If the arrow is displayed in the “front” display region, facing two arrows are displayed toward the center of the image displayable region 120.

The approaching direction information stored in the approaching object direction storage area in the RAM 48 is deleted (54), to end the alarm display processing.

As hereinabove described, by comparing picked up images of the outside worlds obtained by using the camera 7 at a predetermined interval, the HMD 200 can grasp an approaching object. The HMD 200 displays the arrow in the image displayable region 120, to warn the user 3 of a direction from which the object is approaching. By confirming the arrow as the guide information, the user 3 can more easily grasp the direction from which the object is approaching and handle it by unconsciously looking at the direction of the approaching object.

The present disclosure is not limited to the described embodiment and, of course, any and all modifications etc. should be considered to be within the scope of the present disclosure without departing the gist of the present disclosure. The aforesaid matching processing (S42 in FIG. 6) has used normalized correlation to obtain a correlation value between the first outline data target region and the second outline data target region. However, the present disclosure is not limited to it. For example, the normalized correlation method may be replaced with the difference method or the sum of absolute differences method requiring fewer calculations. Further, although pixel values have been used in calculation of correlation values, pixel luminance values may be used instead.

To extract the outline data (S33, S36 in FIG. 6), primary differentiation has been used. However, the present disclosure is not limited to it. For example, secondary differentiation may be used to differentiate a gradient once more and calculate the intensity of the outline.

The arrow 300 has been shown to the user 3 wearing the HMD 200 so that the user might be notified of a direction from which the object would be approaching. However, the present disclosure is not limited to it. For example, the indicative arrow 300 may be moved at a predetermined speed in the approaching direction. This enables the user 3 to more unconsciously grasp the direction from which the object is approaching as looking at an image displayed in the image display region 110. Further, the user can unconsciously move its line of sight in the indicated direction. It is to be noted that if the speed of the approaching object is fast, the movement of the arrow 300 may be made fast. If the object is moving slowly, the movement of the arrow 300 may be slowed down. Further, the arrow 300 may be blinked.

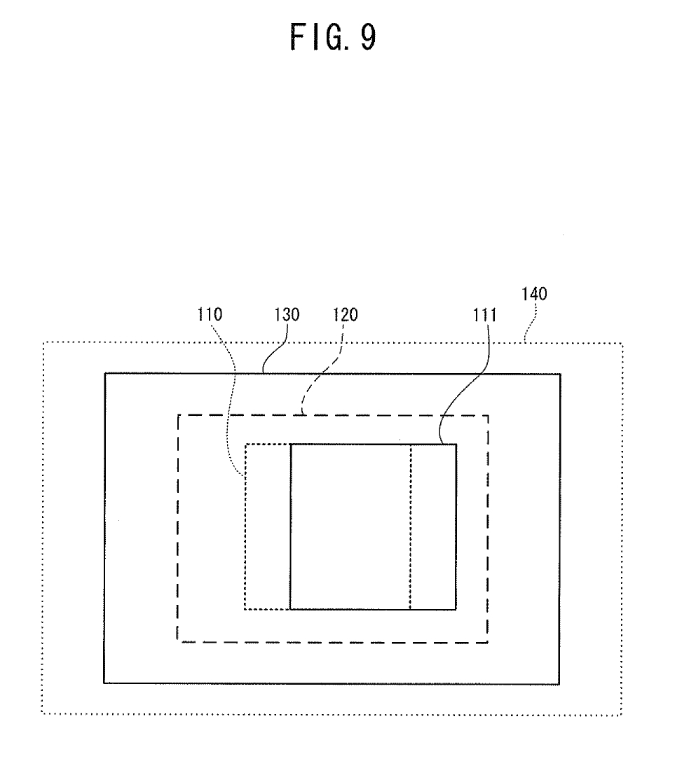

The alarm display indicating the object's approaching direction is not limited to the arrow 300. For example, the image display region 110 in which an image is displayed may be moved in the object's approaching direction. It will be described in detail with reference to FIG. 9.

As shown in FIG. 9, in a state where no approaching object is detected, the image display region 110 is positioned roughly to the center of the image displayable region 120. In other words, a portion of the image displayable region 120 is used as the image display region 110. When an approaching object is detected in the approaching object detection processing (see FIG. 6), the alarm display processing (see FIG. 7) moves the image display region 110 in an approaching direction. FIG. 9 shows a case where an object is approaching from the right side of the HMD 200. In this case, to notify the user 3 of the object is approaching from the right side, the image display region 110 ordinarily positioned to the center moves to the right-of-center position of image display region 111. This enables the user 3 to grasp the object's approaching direction more unconsciously as looking at a displayed image. Further, the user 3 can gradually move its line of sight in the object's approaching direction unconsciously. This manner may be achieved by moving the image displayable region 120 itself in an approaching direction. Moving the image displayable region 120 may be possible by moving an image forming device (e.g., a scanning mirror, LCD) in a direction perpendicular to an optical axis of the emitting device 100.

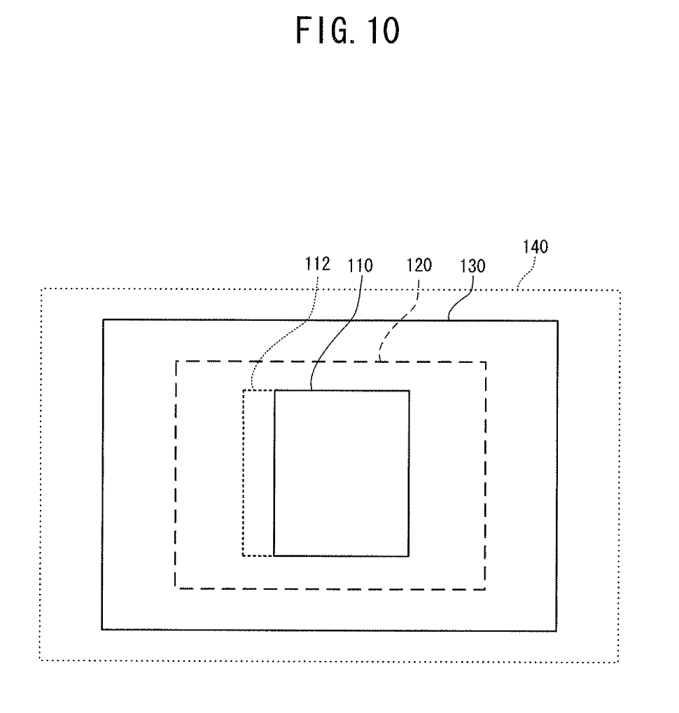

Further, to show the user 3 the object's approaching direction, the image displayed in the image display region 110 may be erased in the object's approaching direction. It will be described in detail with reference to FIG. 10.

As shown in FIG. 10, in a state where no approaching object is detected, the image display region 110 is positioned roughly to the center of the image displayable region 120. When an approaching object is detected in the approaching object detection processing (see FIG. 6), the alarm display processing (see FIG. 7) gradually erases the image display region 110 in the object's approaching direction starting with the end on the opposite side of this approaching direction. In FIG. 10, the object is approaching from the right side of the HMD 200, and the image display region 110 is gradually erased rightward from its left side, so that the left end (erased portion 112) of the image display region 110 is already erased. This enables the user 3 to more unconsciously grasp the object's approaching direction as looking at the displayed image. Further, the user 3 can move its line of sight unconsciously in the object's approaching direction.

Further, to indicate the object's approaching direction, the color of the image displayed in the image display region 110 may be changed gradually to a predetermined color in the object's approaching direction. The predetermined color only needs to be such that the user can recognize a change in it. This enables the user to more unconsciously grasp the object's approaching direction as looking at the displayed image. Further, the user can move its line of sight unconsciously in the object's approaching direction.

Further, although the arrow denoting a direction that corresponds to the approaching direction information has been displayed in the image displayable region 120 in S53 in FIG. 7, see-through display may be given of the displayed image so that the user 3 can visually recognize both of the image displayed in the image display region 110 and an image of the outside world. This enables notifying the user 3 of the approaching object. The user 3 can confirm the image of the outside world and so can see the approaching object by himself.

What is claimed is:

1. A head-mounted display comprising:
an image display portion configured to optically emit image light to the eyes of a user;
an approaching object detection portion configured to detect an object approaching the user;
a direction detection portion configured to detect an approaching direction from which the object detected by the approaching object detection portion approaches based on a detection result by the approaching object detection portion; and
a display control portion configured to guide a line of sight of the user in the approaching direction in a display region in which a display image is displayed which is visually recognized by the user based on the image light emitted from the image display portion.

2. The head-mounted display according to claim 1, wherein the display control portion changes a display manner of the display image based on the approaching direction.

3. The head-mounted display according to claim 2, wherein the display control portion moves the display image at a predetermined speed in the approaching direction in the display region.

4. The head-mounted display according to claim 2, wherein the display control portion gradually changes the display image in the display region starting with the end on the opposite side of the approaching direction to the approaching direction.

5. The head-mounted display according to claim 4, wherein the display control portion gradually erases the display image in the display region starting with the end on the opposite side of the approaching direction to the approaching direction.

6. The head-mounted display according to claim 4, wherein the display control portion gradually changes the color of the display image in the display region to a predetermined color starting with the end on the opposite side of the approaching direction to the approaching direction.

7. The head-mounted display according to claim 1, wherein the display control portion displays guide information intended to guide the line of sight of the user in a region corresponding to the approaching direction among the regions obtained by subdividing the display region.

8. The head-mounted display according to claim 7, wherein the display control portion displays an arrow denoting the approaching direction as the guide information.

9. The head-mounted display according to claim 7, wherein the display control portion moves the guide information in the approaching direction.

10. The head-mounted display according to claim 1, wherein the display control portion provides see-through display of the display image in the display region on the image display portion.

11. A head-mounted display comprising:
an image display configured to be mounted on the head of a user;
an approaching object detector configured to detect an object approaching the user; and
a processor that is configured to execute instructions that:
detect an approaching direction from which the object detected by the approaching object detector approaches based on a detection result by the approaching object detector; and
cause the image display to display a display image corresponding to the approaching direction in a display region in which the display images visually recognized by the user are displayed by the image display.
